(19) United States
(12) Patent Application Publication
(10) Pub. No.: US 2026/0329442 A1
(43) Pub. Date: Oct. 22, 2026

(54) DRAM MEMORY CONTROLLER WITH COMMAND COMBINATION

(71) Applicant: Micron Technology, Inc., Boise, ID (US)

(72) Inventors: Abhishek Singh, San Carlos, CA (US); Robert Walker, Raleigh, NC (US)

(21) Appl. No.: 19/186,130

(22) Filed: Apr. 22, 2025

(51) Int. Cl. G06F 3/06

(52) U.S. Cl. CPC G06F 3/0613; G06F 3/0659; G06F 3/0673

(57) ABSTRACT

Various examples are directed to systems and methods of operating a memory device comprising a DRAM memory array. The method may comprise receiving a first memory access request from a first processor component in communication with the memory device, the first memory access request having a first payload size. The method may also comprise selecting from a memory request queue, a second memory access request having a second payload size and combining the first memory access request and the second memory access request into a first memory access command. The method may include executing the first memory access command at the DRAM memory array at a first burst length corresponding to a sum of the first payload size and the second payload size.

### BACKGROUND

Memory devices are typically provided as internal, semiconductor, integrated circuits (ICs) in computers or other electronic devices. There are many different types of memory, including volatile and non-volatile memory. Volatile memory requires power to maintain its data and includes random-access memory (RAM), dynamic random-access memory (DRAM), static RAM (SRAM), or synchronous dynamic random-access memory (SDRAM), among others. Non-volatile memory can retain stored data when not powered and includes flash memory, read-only memory (ROM), electrically erasable programmable ROM (EEPROM), erasable programmable ROM (EPROM), resistance-variable memory, such as phase-change random-access memory (PCRAM), resistive random-access memory (RRAM), magnetoresistive random-access memory (MRAM), or three-dimensional (3D) XPoint™ memory, among others. Properties of memory devices and other electronic devices can be improved by enhancements to the design and fabrication of components of such devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment including a host device and a memory device.

FIG. 2 is a diagram showing one example of the memory array illustrating a plurality of banks that are commonly addressable by row and column.

FIG. 3 illustrates an example of an environment including a host device and memory device demonstrated in different contexts.

FIG. 4 is a schematic of an electrical arrangement of components of an embodiment of an example DRAM device with each of the memory cells having a GAA transistor coupled to a capacitor.

FIG. 5 is a flowchart showing one example of a process flow that may be executed by the memory controller of FIG. 1 in response to a memory access request received from one of the processor components.

FIG. 6 is a flowchart showing another example of a process flow that may be executed by the memory controller of FIG. 1 in response to a memory access request received from one of the processor components.

FIG. 7 is a block diagram illustrating an example of a machine upon which one or more embodiments may be implemented.

### DETAILED DESCRIPTION

Various examples described herein are directed to memory devices and systems for using DRAM memory devices. Various examples described herein involve configuring a memory controller to combine two or more memory requests into a single memory access command, such as a Column Address Strobe (CAS) command.

A memory device may comprise a memory controller and a memory array, such as a DRAM memory array. The memory array may comprise a number of memory cells arranged into rows, columns, banks, bank groups, and rank. In some examples, each respective memory cell can be described by a unique combination of a row, a column, a bank, a bank group, and a rank.

The memory device may be configured to permit multiple sub-arrays within the bank to be addressed in parallel. This may allow the memory device to read from or write to multiple different banks in consecutive cycles. For example, an X8 memory array may include 8 sub-arrays per bank, permitting 8 columns to be addressed in parallel through the eight sub-arrays forming a bank. An X16 memory array may include 16 sub-arrays, permitting 16 columns to be addressed in parallel. An X32 memory array may may comprise 32 sub-arrays, permitting 32 columns to be addressed in parallel, and so on. In some examples, a memory access command can include a Row Address Strobe (RAS) to activate a particular row in a DRAM device and a Column Address Strobe (CAS) to activate a particular column within the particular row. The RAS and CAS commands together specify a particular memory cell in each sub-array. In response to the memory access command, the memory array may configure each respective memory cell corresponding to the indicated column and row for access (e.g., read or write access). The memory array may read or write to each of the configured memory cells in parallel. For example, a read at a particular column and row address in an X8 memory array may return 8 bits. A read at a particular column and row address in an X16 memory array may return 16 bits, and so on.

In some examples, a memory device is configured to perform memory access operations, such as read or write accesses, according to a burst length. The burst length associated with a memory access command describes a number of columns to be accessed. Consider an example memory access command for an X16 memory array describing a bank, row and column address given by (b, r, c) and executed with a burst length of 8. In this example, the memory array may access 16 bits at the same time, starting from the row r and column c. For example, the memory array may access one bit from bank b at row r and column c from sub-array s, one bit from bank b at row r and column c from sub-array s+1, one bit from each bank at row r and column c from sub-array s+2, and so on until 16 bits are accessed, and then increase the column c to c+1 and repeat from all sub-arrays until c+7 for a total of 128 accessed bits. The access to the bits may be a read or a write. In various examples, a memory device may have a configurable burst length. The burst length may be configurable in real time. For example, a memory access command may indicate an associated burst length. In some examples, burst length is configurable at boot time, for example, by changing a Basic Input Output System (BIOS) setting such as, for example, by changing respective Mode Register (MR). In some examples, the burst length of a memory access command is indicated by the command. For example, a memory controller may use different burst lengths for different memory access commands.

In various examples, a memory device is used in conjunction with a host device that comprises multiple different types of processor components that use the memory device in different ways. For example, a host device may include one or more central processing units (CPUs) processor units. A CPU processor unit may comprise a processor chip and/or one or more CPU cores. CPU processor components may perform standard processing at the host device including, for example, contingent or conditional processing. In addition to one or more CPU processor components, some host devices also include one or more hardware accelerator processor components. Hardware accelerator processor components or hardware accelerators are special-purpose processors that are arranged to perform a particular task. Some hardware accelerators are arranged to perform large vector operations in parallel such as, for example, to render or process image or video data and/or to execute trained computerized models.

Different kinds of processor components may make memory access requests having different properties. For example, CPU processor components and hardware accelerator processor components may make memory access requests having different payload sizes. Also, CPU processor components and hardware accelerator processor components may access the memory device according to different address patterns. For example, a hardware accelerator processor component that is arranged to perform large vector operations in parallel may access the memory device according to a sequential address pattern. The hardware accelerator processor component may consecutively access a large number of contiguous columns of the memory array such as, for example, columns storing data representing matrix elements operated on by the hardware accelerator processor component. On the other hand, a CPU processor component that is performing contingent or conditional operations may exhibit a stride or block stride address pattern. According to a stride or block stride address pattern, the CPU processor component may access a block of memory cells and then randomly access a different block of memory cells. For example, the CPU processor component may first access a first block of memory cells identified by row, column, and block. After performing additional processing, the CPU processor component may next access a second block of memory cells identified by a different row, column, and/or block. The movement or stride between the first block of memory cells and the second block of memory cells may appear random.

The different memory access behavior of different kinds of processor components creates challenges for a memory device. For example, the various processor components of a host device may rely on the memory device to provide data for processing. Accordingly, it is desirable for the memory device to execute received memory access requests quickly and efficiently so as to avoid becoming a bottleneck.

In some examples, a memory controller may be configured to issue memory access commands having a burst length that corresponds to the smallest payload size that is expected to be received. Consider an example system comprising a CPU processor component that makes memory access requests having a 64-byte payload size and a hardware accelerator processor component that makes memory access requests having a 32-byte payload size. In an X16 memory array configurable for burst length 16 and burst length 32 memory access commands, the memory controller may make burst length 16 memory access commands. This allows access to 256 bits or 32 bytes of data. Accordingly, 32-byte memory access request from the hardware accelerator processor component are handled with a single memory access command, while 64-byte memory access requests from the CPU processor will be executed by two different memory access commands, each accessing 32 bytes of the required 64 bytes.

Utilizing a smaller burst length for all memory access commands may prevent inefficiencies associated with using large burst length memory access commands to access smaller amounts of data (e.g., using a burst length 32 command at an X16 memory array to access 32 bytes of data). On the other hand, using a smaller burst length for all memory access commands may increase the total number of commands and, therefore, slow the response of the memory device overall.

Various examples address these and other challenges utilizing a memory device comprising a memory controller that is configured to combine multiple memory access requests from various processor components into a single memory access command. In this way, the memory controller may utilize memory access commands having a higher burst length. This may reduce the likelihood of utilizing larger burst length memory access commands to access smaller amounts a data while at the same time reducing, rather than increasing, the total number of memory access commands to be executed.

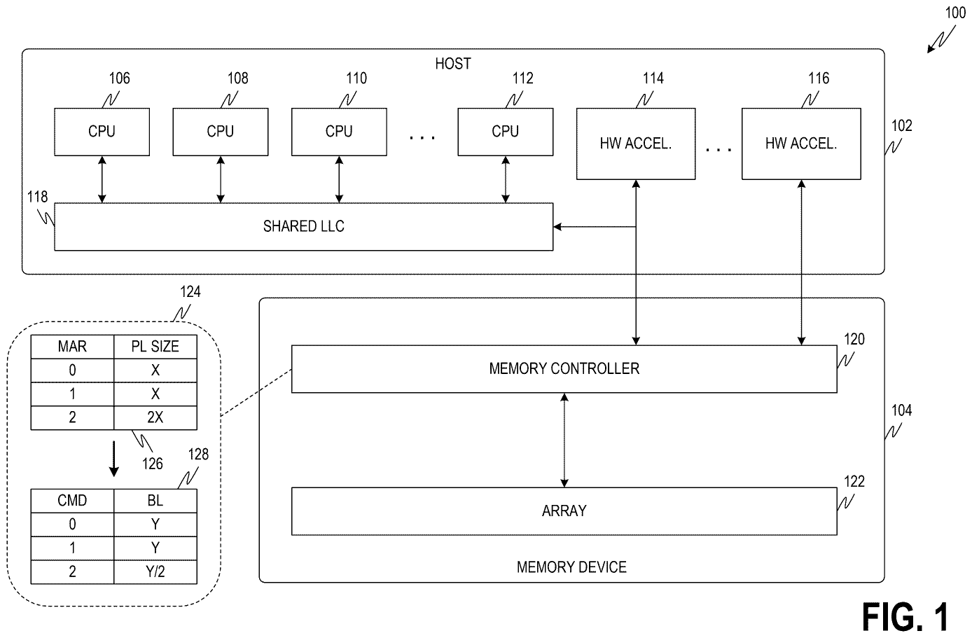

FIG. 1 illustrates an example of an environment 100 including a host device 102 and a memory device 104. The host device 102 comprises processor components 106, 108, 110, 112, 114, and 116. In this example, the processor components 106, 108, 110, 112 are CPU processor components. The CPU processor components 106, 108, 110, 112 may be separate processors on separate silicon dies and/or may be or include CPU cores on a common die. In some examples, the CPU processor components 106, 108, 110, 112 share a common last level cash (LLC) 118. The LLC 118 may store data used by the respective CPU processor components 106, 108, 110, 112 with a smaller access time than the memory device 104. In some examples, memory access requests (e.g. read requests and write requests) from the respective CPU processor components 106, 108, 110, 112 may be requests to read to or write from the LLC 118.

Processor components 114, 116 may be hardware accelerator components. For example, processor components 114, 116 may comprise one or more of a graphics processing unit (GPU), one or more neural processing units, one or more tensor processing units, and/or the like. In some examples, processor components 114, 116 may be implemented utilizing one or more application specific integrated circuits (ASICs), one or more field programmable gate arrays (FPGAs), and/or the like. The host device 102 may implement or be a component of various different systems such as a System-on-Chip (SOC) utilized in data centers, laptop or desktop computers, mobile telephones and other mobile devices, and/or the like.

The memory device 104 comprises a memory controller 120 and a memory array 122. The memory array 122 may, in some examples, be a DRAM memory array. The memory controller 120 may implement one or more management tables such as, for example, a memory request queue 126 and a memory command queue 128 illustrated in breakout window 124. Upon receiving a memory access request (MAR) from one or more of the processor components 106, 108, 110, 112, 114, 116, the memory controller may review the memory request queue 126 to identify any other memory access requests that are combinable with the received memory access request. For example, two memory access requests may be combinable if the sum of the payload sizes of the memory access requests is equal to or less than the data readable at the burst length used by the memory controller, and if the referenced payload data is at the same bank at contiguous columns.

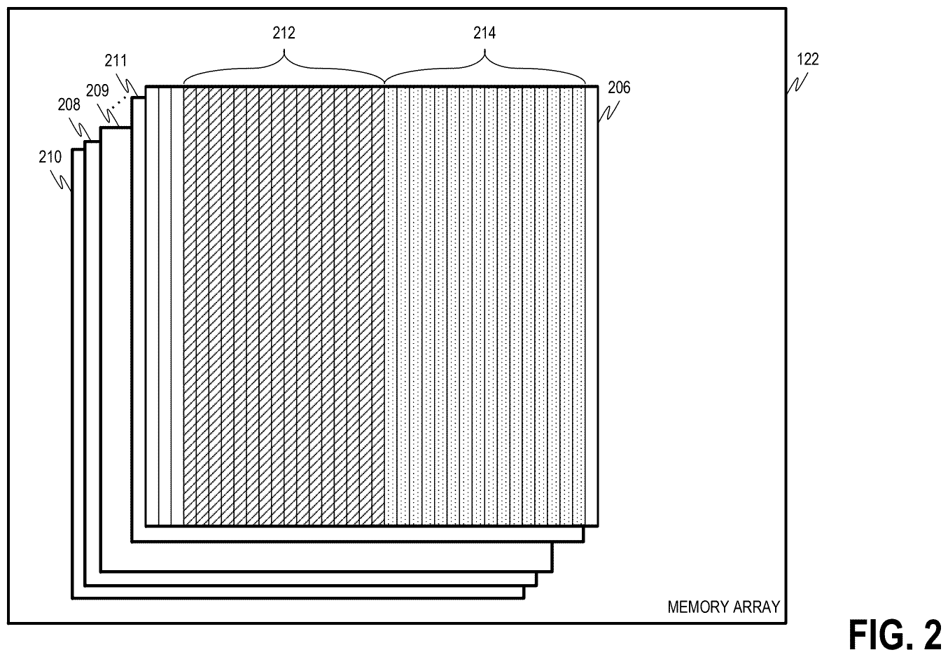

FIG. 2 is a diagram showing one example of the memory array 122 illustrating a plurality of sub-arrays 206, 208, 209, 210, 211 that are commonly addressable by row and column. In this example, five sub-arrays 206, 208, 209, 210, 211 are illustrated. In various examples, different numbers of sub-arrays may be illustrated such as, for example, sixteen. In this example, a first memory request is received from a processor component 106, 108, 110, 112, 114, 116 and a second memory request is received from another processor component 106, 108, 110, 112, 114, 116. The first memory request and the second memory request may be received from the same processor component or from different processor components. Also, for example, the first memory request and second memory request may be read requests, write requests, and/or the like.

In this example, the first memory request includes access to data at a first set of columns 212 and the second memory requests includes access to data at a second set of columns 214. In this example, the set of columns 212 and the set of columns 214 each include 16 columns. Further, in this example, the set of columns 212 and the set of columns 214 are contiguous. For example, the last column of the set of columns 212 and the first column of the set of columns 214 are adjacent. For example, the last column of the set of columns 212 in the first column of the set of columns 214 have consecutive column addresses at the memory array 122. Accordingly, the first memory request and the second memory requests are directed to the same bank (e.g. bank 122), and to contiguous sets of columns (e.g. the set of columns 212 and the set of columns 214). In some examples, the memory controller 120 is configured to combine the first memory request and the second memory request into a common memory access command that is executed with a burst length of 32 instead of, for example, two memory access commands with respective burst lengths of 16. This may allow reading to and/or writing from all of the data locations indicated by the first memory request and the second memory request in a single memory access command.

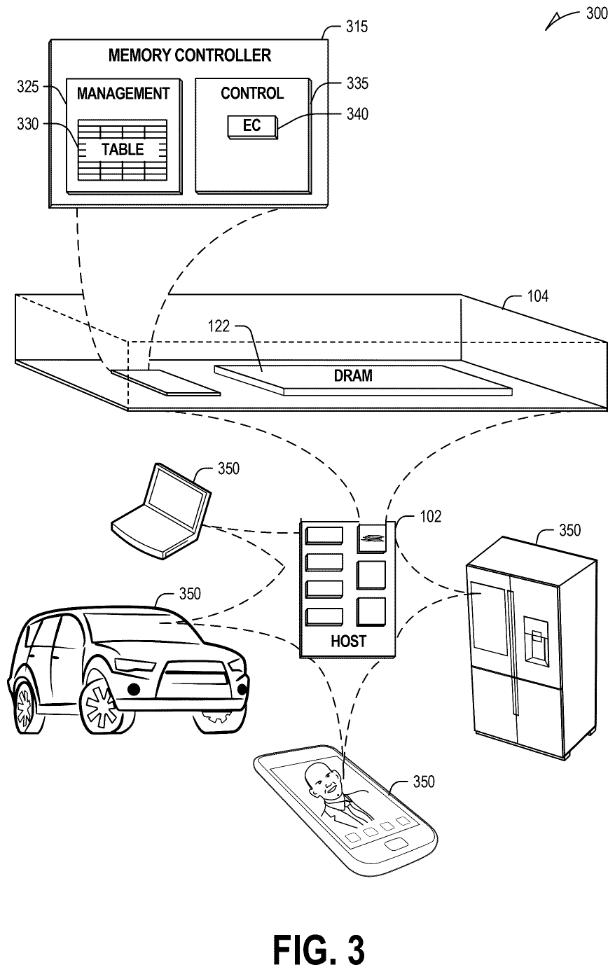

FIG. 3 illustrates an example of an environment 300 including the host device 102 and the memory device 104 demonstrated in different contexts. The host device 102 and memory device 104 may be configured to communicate over a communication interface. An electronic device comprising the host device 102 and/or the memory device 104 may be included in a variety of products 350, such as Internet of Things (IoT) devices (e.g., a refrigerator or other appliance, sensor, motor or actuator, mobile communication device, automobile, drone, and/or the like), computers (e.g., laptop computers, desktop computers, and/or the like) to support processing, communications, or control of the product 350.

The memory device 104 includes a memory controller 120 and a memory array 122 including, for example, a number of individual memory die (e.g., one or more 2D or 3D DRAM arrays). In 3D architecture semiconductor memory technology, vertical structures are stacked, increasing the number of tiers, physical pages, and accordingly, the density of a memory device (e.g., a storage device). In an example, the memory device 104 can be a discrete memory or storage device component of the host device 102. In other examples, the memory device 104 can be a portion of an integrated circuit (e.g., system on a chip (SOC), etc.), stacked or otherwise included with one or more other components of the host device 102.

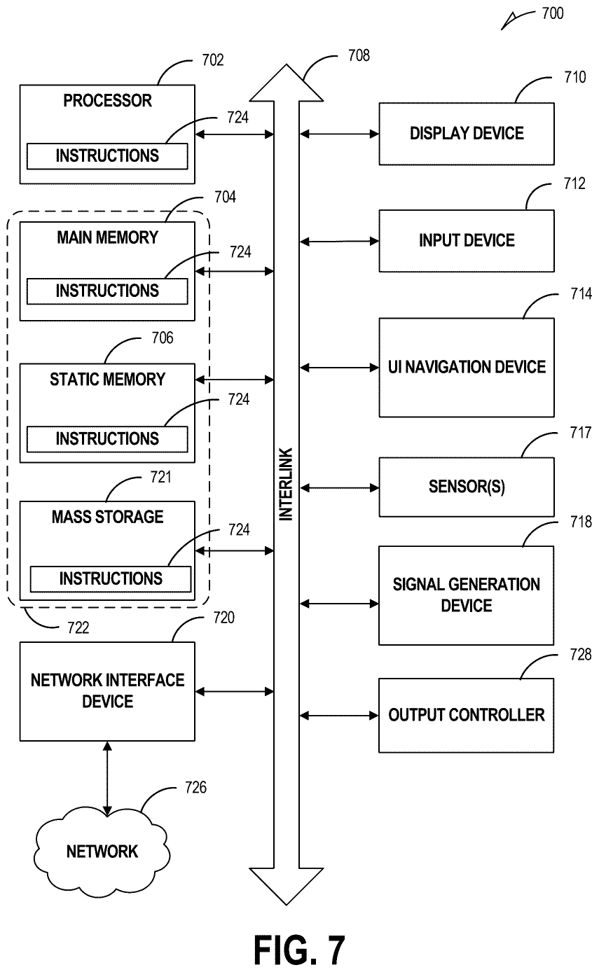

One or more communication interfaces can be used to transfer data between the memory device 104 and one or more other components of the host device 102, such as a Serial Advanced Technology Attachment (SATA) interface, a Peripheral Component Interconnect Express (PCIe) interface, a Universal Serial Bus (USB) interface, or one or more other connectors or interfaces. The host device 102 can include a host system, an electronic device, a processor, a memory card reader, or one or more other electronic devices external to the memory device 104. In some examples, the host device 102 may be a machine having some portion, or all, of the components discussed in reference to the machine 700 of FIG. 7.

Electronic devices, such as mobile electronic devices (e.g., smartphones, tablets, etc.), electronic devices for use in automotive applications (e.g., automotive sensors, control units, driver-assistance systems, passenger safety or comfort systems, etc.), and internet-connected appliances or devices (e.g., IoT devices, etc.), have varying storage needs depending on, among other things, the type of electronic device, use environment, performance expectations, etc.

Electronic devices can be broken down into several main components: one or more processor components (e.g., a CPU processor component and one or more hardware accelerator processor components); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, an SSD, an MMC, or other memory card structure or assembly, etc.). In certain examples, electronic devices can include a user interface (e.g., a display, touch-screen, keyboard, one or more buttons, etc.), a graphics processing unit (GPU), a power management circuit, a baseband processor, or one or more transceiver circuits, etc.

The memory controller 120 can receive instructions from the host device 102, and can communicate with the memory array 122, such as to transfer data to (e.g., write or erase) or from (e.g., read) one or more of the memory cells, planes, sub-banks, banks, or pages of the memory array. The memory controller 120 can include, among other things, circuitry or firmware, including one or more components or integrated circuits. For example, the memory controller 120 can include one or more memory control units, circuits, or components configured to control access across the memory array 122 and to provide a translation layer between the host device 102 and the memory device 104. The memory controller 120 can include one or more input/output (I/O) circuits, lines, or interfaces to transfer data to or from the memory array 122. The memory controller 120 can include a memory manager 325 and an array controller 335.

The memory manager 325 can include, among other things, circuitry or firmware, such as a number of components or integrated circuits associated with various memory management functions. For purposes of the present description example memory operation and management functions will be described in the context of DRAM memory. Persons skilled in the art will recognize that other forms of volatile or non-volatile memory may have analogous memory operations or management functions. Such DRAM management functions include memory cell refresh, scheduling, error detection or correction, or one or more other memory management functions. The memory manager 325 can parse or format host commands (e.g., commands received from a host) into device commands (e.g., commands associated with the operation of a memory array, etc.), or generate device commands (e.g., to accomplish various memory management functions) for the array controller 335 or one or more other components of the memory device 104.

The memory manager 325 can include a set of management tables 330 configured to maintain various information associated with one or more components of the memory device 104 (e.g., various information associated with a memory array or one or more memory cells coupled to the memory controller 120). For example, the management tables 330 can include information regarding one or more error counts (e.g., a write operation error count, a read bit error count, a read operation error count, an erase error count, etc.) for one or more portions of the memory cells coupled to the memory controller 120. In some examples, the management tables 330 also include the memory access request queue 126 and the memory command queue 128.

The array controller 335 can include, among other things, circuitry or components configured to control memory operations associated with writing data to, reading data from, or erasing one or more memory cells of the memory device 104 coupled to the memory controller 120. The memory operations can be based on, for example, host commands received from the host device 102, or internally generated by the memory manager 325 (e.g., in association with refreshing, error detection or correction, etc.).

The array controller 335 can include an error correction circuit 340. In some examples, the error correction circuit 340 is arranged to implement error correction code (ECC) or another suitable error correction algorithm. For example, when data is to be written to a page or other subunit of memory cells of the memory array 122, the error correction circuit 340 may generate one or more parity bits based on the data. The parity bits are written to one or more memory cells at the array, for example, in association with the data. When data is read from the memory array, the data and its associated parity bit or bits are provided to the error correction circuit 340. The error correction circuit may use the parity bits to, if possible, detect and correct any bit errors that may have occurred. In some examples, the error correction circuit 340 may be implemented in software that is executed by a processor, a microcontroller, or other suitable hardware at the memory controller 120.

The memory array 122 can include a number of memory cells arranged in, for example, a number of devices, planes, sub-banks, banks, pages, and/or the like. In some examples, the memory array 122 may be arranged in three dimensions physically, and/or logically. For example, memory cells in the memory array 122 may be arranged into rows, columns, banks, and other subdivisions. In some examples, the memory array 122 can be divided into banks. Each bank of the memory array may be a group of memory cells that share a common internal bus. Accordingly, each bank may comprise a number of rows and a number of columns.

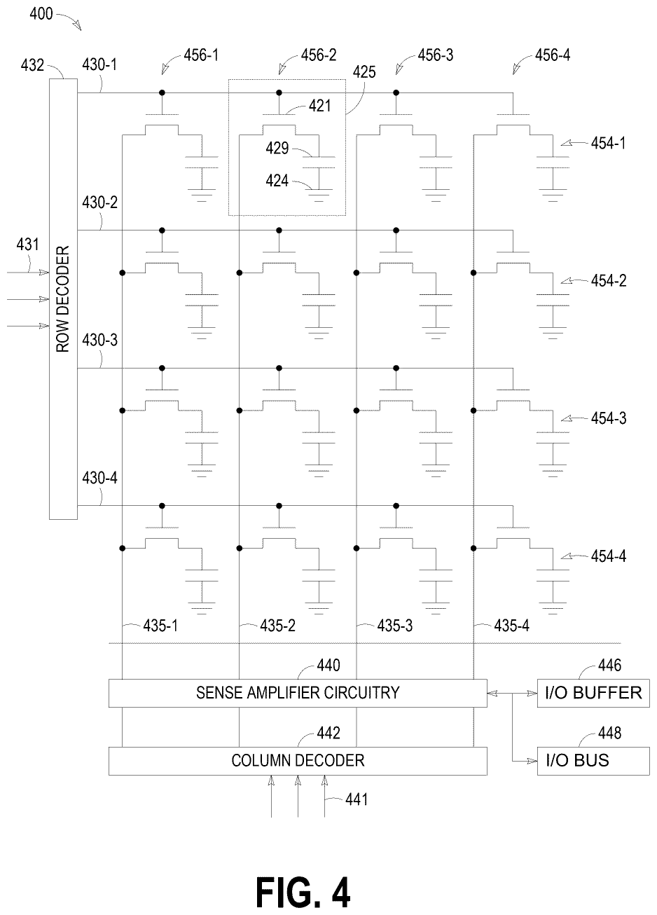

FIG. 4 is a schematic of an electrical arrangement of components of an embodiment of an example DRAM device 400 with each of the memory cells having a GAA transistor coupled to a capacitor. In some examples, the arrangement of FIG. 4 illustrates a bank of memory cells as depicted and described herein. The memory cells can be coupled to bit lines (BLs), where each of the BLs may be wrapped on a sidewall of an active area of the GAA transistor of each memory cell to which the BL is coupled. Each word line (WL) can be structured by contacting gates of GAA transistors of memory cells to which the given WL is coupled. The DRAM device 400 can include an array of memory cells 425 (only one being labeled in FIG. 4 for ease of presentation) arranged in rows 454-1, 454-2, 454-3, and 454-4 and columns 456-1, 456-2, 456-3, and 456-4. The physical orientation of the rows and columns is not shown. Further, while only four rows 454-1, 454-2, 454-3, and 454-4 and four columns 456-1, 456-2, 456-3, and 456-4 of four memory cells are illustrated, DRAM devices, like DRAM device 400, can have significantly more memory cells 425 (for example, tens, hundreds, or thousands of memory cells) per row or per column.

In this example, each memory cell 425 can include a single transistor 421 and a single capacitor 429, which is commonly referred to as a 1T1C (one-transistor—one capacitor cell). One plate of capacitor 429, which can be termed the “node plate,” is connected to the drain terminal of transistor 421, whereas the other plate of the capacitor 429 is connected to ground 424 or other reference node. Each capacitor 429 within the array of 1T1C memory cells 425 typically serves to store one bit of data, and the respective transistor 421 serves as an access device to write to or read from storage capacitor 429.

The transistor gate terminals within each row of rows 454-1, 454-2, 454-3, and 454-4 are portions of respective WLs 430-1, 430-2, 430-3, and 430-4, and the transistor source terminals within each of columns 456-1, 456-2, 456-3, and 456-4 are electrically connected to respective BLs 435-1, 435-2, 435-3, and 435-4. A row decoder 432 can selectively drive the individual WLs 430-1, 430-2, 430-3, and 430-4, responsive to row address signals 431 input to row decoder 432. Driving a given WL at a high voltage causes the access transistors within the respective row to conduct, thereby connecting the storage capacitors within the row to the respective BLs, such that charge can be transferred between the BLs and the storage capacitors for read or write operations. Both read and write operations can be performed via SA circuitry 440, which can transfer bit values between memory cells 425 of the selected row of the rows 454-1, 454-2, 454-3, and 454-4 and input/output buffers 446 (for write/read operations) or external input/output data buses 448.

A column decoder 442 responsive to column address signals 441 can select which of the memory cells 425 within the selected row is read out or written to. Alternatively, for read operations, the storage capacitors 429 within the selected row can be read out simultaneously and latched, and the column decoder 442 can then select which latch bits to connect to the output data bus 448. Since read-out of the storage capacitors destroys the stored information, the read operation is accompanied by a simultaneous rewrite of the capacitor charge. Further, in between read/write operations, the capacitor charge is repeatedly refreshed to prevent data loss. Details of read/rewrite, write, and refresh operations are well-known to those of ordinary skill in the art.

DRAM device 400 can be implemented as an IC within a package that includes pins for receiving supply voltages (for example, to provide the source and gate voltages for the transistors 421) and signals (including data, address, and control signals). FIG. 4 depicts DRAM device 400 in simplified form to illustrate basic structural components, omitting many details of the memory cells 425 and associated WLs 430-1, 430-2, 430-3, and 430-4 and BLs 435-1, 435-2, 435-3, and 435-4 as well as the peripheral circuitry. For example, in addition to the row decoder 432, column decoder 442, Sense Amplifier (SA) circuitry 440, and buffers 446, DRAM device 400 can include further peripheral circuitry, such as a memory control circuit (e.g., the memory control circuit 315). The memory control circuit may control the memory operations based on control signals (provided, for example, by a host device, an external processor), additional input/output circuitry, or other features associated with a memory device. The peripheral circuitry can be located above the array of memory cells 425 in a CoA architecture using a wafer-to-wafer interconnect architecture. Alternatively, the peripheral circuitry can be located under the array of memory cells 425 in a CuA architecture. Alternatively, the peripheral circuitry can be located in a region of the IC of the memory device adjacent an array region having the array of memory cells 425.

In two-dimensional (2D) DRAM arrays, the rows 454-1, 454-2, 454-3, and 454-4 and columns 456-1, 456-2, 456-3, and 456-4 of memory cells 425 can be arranged along a single horizontal plane (i.e., a plane parallel to the layers) of the semiconductor substrate, for example, in a rectangular lattice with WLs 430-1, 430-2, 430-3, and 430-4 and BLs 435-1, 435-2, 435-3, and 435-4. In 3D DRAM arrays, the memory cells 425 can be arranged in a 3D lattice with a page of memory cells and associated WLs and BLs at a level above another page of memory cells and their associated WLs and BLs.

Memory devices having identical or similar features as example DRAM device 400 can be implemented in a variety of electronic host devices. Electronic host devices, such as mobile electronic devices (for example, smartphones, tablets, and other similar communication-related devices), electronic devices for use in automotive applications (for example, automotive sensors, control units, driver-assistance systems, passenger safety systems, comfort systems, or other similar systems), and internet-connected appliances or devices (for example, internet-of-things (IoT) devices, or other network-related devices), have varying storage needs depending on, among other things, the type of electronic device, use environment, performance expectations, or other criteria.

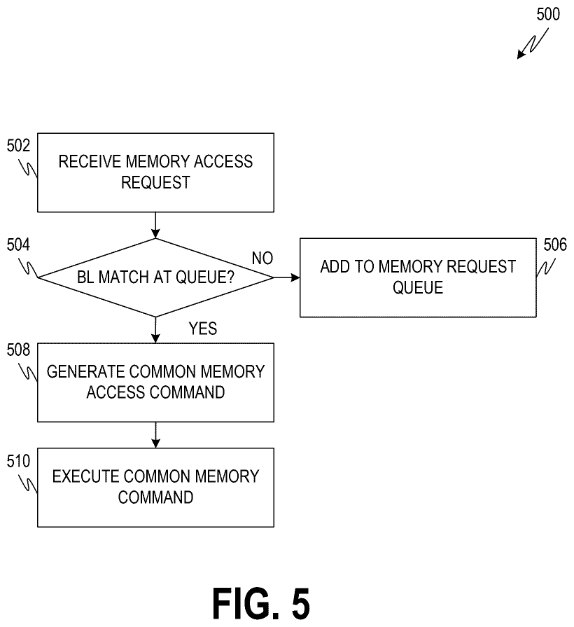

FIG. 5 is a flowchart showing one example of a process flow 500 that may be executed by the memory controller 120 in response to a memory access request received from one of the processor components 106, 108, 110, 112, 114, 116. At operation 502, the memory controller 120 receives a memory access request from one of the processor components 106, 108, 110, 112, 114, 116. The memory access request may be a read request and/or a write request. In examples where the memory access request is a read request, the memory access request may include an identifier or address of the data to be read from the memory array 122. The data to be read may have a size, which is the payload size of the read request. In examples where the memory access request is a write request, the memory access request may include payload data that is to be written to the memory array 122. The size of the payload data included with the write request may be the payload size of the write request.

At operation 504, the memory controller 120 may determine if the memory access request received at operation 502 can be matched with any other memory access requests stored at the memory access request queue 126. Multiple memory access requests may be combinable, for example, if the memory access requests are directed to continuous columns at the same bank. In some examples, the memory request may also have payload sizes that, when summed, are equal to or less than a memory access command burst length. (Burst length is abbreviated as “BL” in FIG. 5).

If the memory access request received at operation 502 cannot be combined with any other memory access requests at the memory access request queue 126, the memory controller 120 may queue the received memory request by adding it to the memory access request queue 126 at operation 506.

If the memory access request received at operation 502 can be combined with another memory access request at the memory access request queue 126, then the memory controller 120 may generate a common memory access command at operation 508. The common memory access command may indicate the set of continuous columns associated with the payloads of the two memory access commands. The common memory access command may have a burst length, for example, equal to a larger burst length available at the memory device one of four. For example, in a memory device that supports a burst length of 16 and a burst length of 32, the common memory access command generated at operation 508 may be generated to indicate the burst length of 32. In some examples, the burst length of memory commands directed to the memory array 122 is configured at boot time and, therefore, may not be indicated by the memory access command itself.

At operation 510, the memory array 122 may execute the common memory command. This may include configuring the memory array 122 so that the contiguous sets of columns associated with the first and second memory access requests are accessible. In some examples, the executing of the common memory command may also include executing a read and/or a write at the accessible columns. In some examples, the memory controller 120 may provide an additional read or write command to be executed at the memory array 122 after execution of a memory access command. For example, the memory access command may make a row and/or a column of the memory array 122 available to read. A subsequent read or write command may cause the requested read or write to the indicated row and/or column.

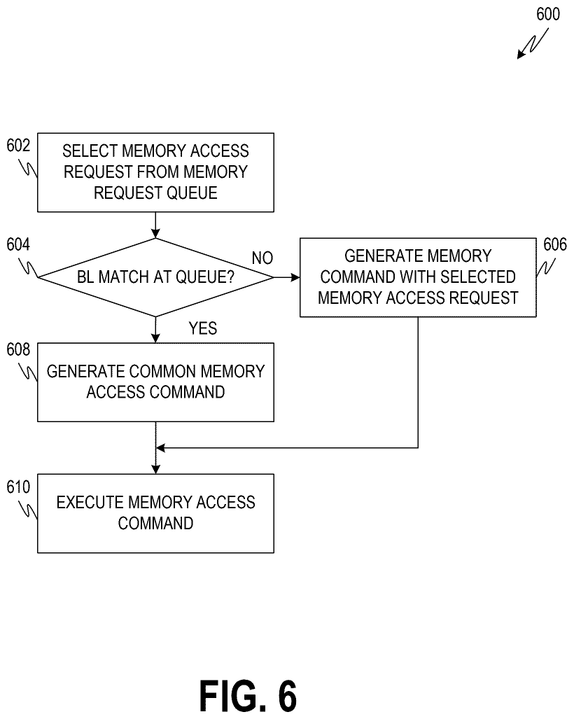

FIG. 6 is a flowchart showing another example of a process flow 600 that may be executed by the memory controller 120 in response to a memory access request received from one of the processor components 106, 108, 110, 112, 114, 116. FIG. 6 describes an example in which memory access requests at the memory access request queue 126 are matched and consolidated into a common memory access command.

At operation 602, the memory controller 120 selects a memory access request from the memory access request queue 126. In some examples, the memory access request queue 126 may be a First-In-First-Out (FIFO) data structure. The selected memory access request, then, may be the first memory access request to have been added to the memory access request queue 126. Also, in some examples, the memory access request queue 126 may be a Last-In-First-Out (LIFO) data structure. The selected memory access request, then, may be the last memory access request to have been added to the memory access request queue 126. In other examples, the memory controller 120 may select the memory access request at operation 602 according to various other criteria. For example, the memory controller 120 may process memory requests from different processor components according to a desired ratio or other formula or priority scheme.

The selected memory access request may be a read request and/or a write request. In examples where the selected memory access request is a read request, the selected memory access request may include an identifier or address of the data to be read from the memory array 122. The data to be read may have a size, which is the payload size of the read request. In examples where the selected memory access request is a write request, the selected memory access request may include payload data that is to be written to the memory array 122. The size of the payload data included with the write request may be the payload size of the write request.

At operation 604, the memory controller 120 may determine if the selected memory access request can be matched with any other memory access requests stored at the memory access request queue 126. Two memory access requests may be combinable, for example, if the memory access requests are directed to adjacent or continuous columns at the same bank. In some examples, the memory request may also have payload sizes that, when summed, are equal to or less than a memory access command burst length.

If the selected memory access request cannot be combined with any other memory access requests at the memory access request queue 126, then, at operation 606, the memory controller 120 may generate a memory access command based on the selected memory access request. The memory access command may be executed at a burst length corresponding to the selected memory access request, and/or at a larger burst length. The memory access command generated at operation 606 may be executed at operation 610. In some examples, the burst length of the memory access command generated at operation 606 may be greater than the payload size of the memory access request selected at operation 602. As a result, the memory array 122 may make additional columns available that are not used to respond to the memory access request selected at operation 602. For example, if the memory access request selected at operation 602 is a write request, then the memory array 122 may execute the memory access command and more columns than are needed to write the payload data. Also, for example, if the memory access request selected at operation 602 is a read request, the memory array 122 may return data in addition to what was requested. The memory controller 120 may be configured to mask a portion of the return data corresponding to columns that store data not responsive to the memory access request selected at operation 602. The masked data may be returned to the requesting processor component.

If the selected memory access request can be combined with another memory access request at the memory access request queue 126, then the memory controller 120 may generate a common memory access command at operation 608. The common memory access command may indicate the set of continuous columns associated with the payloads of the two memory access commands. The common memory access command may have a burst length, for example, equal to a larger burst length available at the memory device 104. For example, in a memory device that supports a burst length of 16 and a burst length of 32, the common memory access command generated at operation 608 may be generated to indicate the burst length of 32. Also, in some examples, the burst length of memory commands directed to the memory array 122 is configured at boot time and, therefore, may not be indicated by the memory access command itself.

At operation 610, the memory device may execute the common memory access command. This may include configuring the memory array 122 so that the contiguous sets of columns associated with the first and second memory access request are accessible. In some examples, the executing of the common memory access command may also include executing a read and/or a write at the accessible columns.

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine (e.g., computer system) 700 (e.g., the host device 102, the memory device 104, etc. ,) may include a hardware processor 702 (e.g., a CPU, a GPU, a hardware processor core, or any combination thereof, such as the memory control circuit 315, etc.), a main memory 704, and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712, and UI navigation device 714 may be a touch screen display. The machine 700 may additionally include a storage device, a signal generation device 718 (e.g., a speaker), a network interface device 720, and one or more sensors 717, such as a global positioning system (GPS) sensor, compass, accelerometer, or other sensor. The machine 700 may include an output controller 728, such as a serial (e.g., USB, parallel, or other wired or wireless (e.g., infrared (IR), near field communication (NFC), etc.) connection to communicate or control one or more peripheral devices (e.g., a printer, card reader, etc.).

The storage device 722 may include a non-transitory machine readable medium on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 722 may constitute the machine readable medium.

While the machine readable medium is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine-readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., EPROM, EEPROM) and flash memory devices; magnetic disks, such as internal hard disks and removable disks; magneto-optical disks; and CD-ROM and DVD-ROM disks.

The instructions 724 (e.g., software, programs, an operating system (OS), etc.) or other data are stored on a storage device 721, can be accessed by the memory 704 for use by the processor 702. The memory 704 (e.g., DRAM) is typically fast, but volatile, and thus a different type of storage than the storage device 721 (e.g., an SSD), which is suitable for long-term storage, including while in an “off” condition. The instructions 724 or data in use by a user or the machine 700 are typically loaded in the memory 704 for use by the processor 702. When the memory 704 is full, virtual space from the storage device 721 can be allocated to supplement the memory 704; however, because the storage device 721 device is typically slower than the memory 704, and write speeds are typically at least twice as slow as read speeds, use of virtual memory can greatly reduce user experience due to storage device latency (in contrast to the memory 704, e.g., DRAM). Further, use of the storage device 721 for virtual memory can greatly reduce the usable lifespan of the storage device 721.

In contrast to virtual memory, virtual memory compression (e.g., the Linux® kernel feature “ZRAM”) uses part of the memory as compressed block storage to avoid paging to the storage device 721. Paging takes place in the compressed block until it is necessary to write such data to the storage device 721. Virtual memory compression increases the usable size of memory 704, while reducing wear on the storage device 721.

Storage devices optimized for mobile electronic devices, or mobile storage, traditionally include MMC solid-state storage devices (e.g., micro Secure Digital (microSD™) cards, etc.). MMC devices include a number of parallel interfaces (e.g., an 8-bit parallel interface) with a host device, and are often removable and separate components from the host device. In contrast, eMMC™ devices are attached to a circuit board and considered a component of the host device, with read speeds that rival SATA based SSD devices. However, demand for mobile device performance continues to increase, such as to fully enable virtual or augmented-reality devices, utilize increasing networks speeds, etc. In response to this demand, storage devices have shifted from parallel to serial communication interfaces. UFS devices, including controllers and firmware, communicate with a host device using a low-voltage differential signaling (LVDS) serial interface with dedicated read/write paths, further advancing greater read/write speeds.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments in which the disclosure can be practiced. These embodiments are also referred to herein as “examples,” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” may include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

Operating a memory cell, as used herein, includes reading from, writing to, or erasing the memory cell. The operation of placing a memory cell in an intended state is referred to herein as “programming,” and can include both writing to or erasing from the memory cell (e.g., the memory cell may be programmed to an erased state).

It will be understood that when an element is referred to as being “on,” “connected to,” or “coupled with” another element, it can be directly on, connected, or coupled with the other element or intervening elements may be present. In contrast, when an element is referred to as being “directly on,” “directly connected to,” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, RAMs, ROMs, SSDs, UFS device, eMMC device, and the like.

### EXAMPLES

Example 1 is a memory device comprising: a DRAM memory array comprising a number of memory cells arranged into a number of pages, a number of rows, and a number of columns, each respective memory cell of the number of memory cells being part of a column of the number of columns, and a row of the number of rows, and a page of the number of pages; and a memory controller programmed to execute operations comprising: receiving a first memory access request from a first processor component in communication with the memory device, the first memory access request having a first payload size; selecting, from a memory request queue, a second memory access request having a second payload size; providing a first memory access command based on the first memory access request and the second memory access request; and executing the first memory access command at the DRAM memory array at a first burst length corresponding to a sum of the first payload size and the second payload size.

In Example 2, the subject matter of Example 1 optionally includes the first memory access request indicating a first set of columns of the number of columns and the second memory access request indicating a second set of columns of the number of columns, and the operations further comprising determining that the first set of columns is continuous with the second set of columns.

In Example 3, the subject matter of any one or more of Examples 1-2 optionally include the first payload size and the second payload size being equal.

In Example 4, the subject matter of any one or more of Examples 1-3 optionally include the operations further comprising: receiving a third memory access request, the third memory access request having a third payload size, the first burst length corresponding to the third payload size; and executing a second memory access command at the DRAM memory array at the first burst length, the second memory access command corresponding to the third memory access request.

In Example 5, the subject matter of any one or more of Examples 1-4 optionally include the operations further comprising: receiving a third memory access request having a third payload size equivalent to the first payload size; determining that the memory request queue does not include another memory access request combinable with the third memory access request at the first burst length; executing a second memory access command at the DRAM memory array at the first burst length, the second memory access command corresponding to the third memory access request; masking a portion of returned data returned by the DRAM memory array in response to the second memory access command to generate masked returned data; and returning the masked returned data in response to the third memory access request.

In Example 6, the subject matter of any one or more of Examples 1-5 optionally include the operations further comprising: receiving a third memory access request having a third payload size equivalent to the first payload size; determining that the memory request queue does not include another memory access request combinable with the third memory access request at the first burst length; and executing a second memory access command at the DRAM memory array at a second burst length that is different than the first burst length, the second memory access command corresponding to the third memory access request.

In Example 7, the subject matter of any one or more of Examples 1-6 optionally include the first processor component being a central processor unit (CPU) and the second memory access request being received from a second processor component that is a hardware accelerator component.

In Example 8, the subject matter of Example 7 optionally includes the CPU being programmed to access the memory device with a block stride access pattern and the hardware accelerator component being programmed to access the memory device with a sequential access pattern.

In Example 9, the subject matter of any one or more of Examples 7-8 optionally include the operations further comprising queuing the first memory access command for execution at a memory access command queue.

In Example 10, the subject matter of any one or more of Examples 1-9 optionally include the operations further comprising: before the receiving of the first memory access request, receiving the second memory access request from a second processor component; and queuing the second memory access request to the memory request queue.

Example 11 is a method of operating a memory device comprising a DRAM memory array comprising a number of memory cells arranged into a number of pages, a number of rows, and a number of columns, each respective memory cell of the number of memory cells being part of a column of the number of columns, and a row of the number of rows, and a page of the number of pages, the method comprising: receiving a first memory access request from a first processor component in communication with the memory device, the first memory access request having a first payload size; selecting from a memory request queue, a second memory access request having a second payload size; providing a first memory access command based on the first memory access request and the second memory access request; and executing the first memory access command at the DRAM memory array at a first burst length corresponding to a sum of the first payload size and the second payload size.

In Example 12, the subject matter of Example 11 optionally includes the first memory access request indicating a first set of columns of the number of columns and the second memory access request indicating a second set of columns of the number of columns, further comprising determining that the first set of columns is continuous with the second set of columns.

In Example 13, the subject matter of any one or more of Examples 11-12 optionally include the first payload size and the second payload size being equal.

In Example 14, the subject matter of any one or more of Examples 11-13 optionally include receiving a third memory access request, the third memory access request having a third payload size, the first burst length corresponding to the third payload size; and executing a second memory access command at the DRAM memory array at the first burst length, the second memory access command corresponding to the third memory access request.

In Example 15, the subject matter of any one or more of Examples 11-14 optionally include receiving a third memory access request having a third payload size equivalent to the first payload size; determining that the memory request queue does not include another memory access request combinable with the third memory access request at the first burst length; executing a second memory access command at the DRAM memory array at the first burst length, the second memory access command corresponding to the third memory access request; masking a portion of returned data returned by the DRAM memory array in response to the second memory access command to generate masked returned data; and returning the masked returned data in response to the third memory access request.

In Example 16, the subject matter of any one or more of Examples 11-15 optionally include receiving a third memory access request having a third payload size equivalent to the first payload size; determining that the memory request queue does not include another memory access request combinable with the third memory access request at the first burst length; and executing a second memory access command at the DRAM memory array at a second burst length that is different than the first burst length, the second memory access command corresponding to the third memory access request.

In Example 17, the subject matter of Example 16 optionally includes queuing the first memory access command for execution at a memory access command queue.

In Example 18, the subject matter of any one or more of Examples 11-17 optionally include before the receiving of the first memory access request, receiving the second memory access request from a second processor component; and queuing the second memory access request to the memory request queue.

Example 19 is a non-transitory machine-readable medium having instructions thereon that, when executed by at least one processor, cause the at least one processor to perform operations comprising: receiving a first memory access request from a first processor component, the first memory access request having a first payload size and directed to a memory device comprising a DRAM memory array comprising a number of memory cells arranged into a number of pages, a number of rows, and a number of columns, each respective memory cell of the number of memory cells being part of a column of the number of columns, and a row of the number of rows, and a page of the number of pages; selecting from a memory request queue, a second memory access request having a second payload size; providing a first memory access command based on the first memory access request and the second memory access request; and executing the first memory access command at the DRAM memory array at a first burst length corresponding to a sum of the first payload size and the second payload size.

In Example 20, the subject matter of Example 19 optionally includes the first memory access request indicating a first set of columns of the number of columns and the second memory access request indicating a second set of columns of the number of columns, further comprising determining that the first set of columns is continuous with the second set of columns.

The above description is intended to be illustrative, and not restrictive. For example, the above-described examples (or one or more aspects thereof) may be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

1. A memory device comprising:
a Dynamic Random Access Memory (DRAM) memory array comprising a number of memory cells arranged into a number of rows and a number of columns, each respective memory cell of the number of memory cells being part of a column of the number of columns and a row of the number of rows; and
a memory controller programmed to execute operations comprising:
receiving a first memory access request from a first processor component in communication with the memory device, the first memory access request having a first payload size;
selecting, from a memory request queue, a second memory access request having a second payload size;
providing a first memory access command based on the first memory access request and the second memory access request; and
executing the first memory access command at the DRAM memory array at a first burst length corresponding to a sum of the first payload size and the second payload size.

2. The memory device of claim 1, the first memory access request indicating a first set of columns of the number of columns and the second memory access request indicating a second set of columns of the number of columns, and the operations further comprising determining that the first set of columns is continuous with the second set of columns.

3. The memory device of claim 1, the first payload size and the second payload size being equal.

4. The memory device of claim 1, the operations further comprising:
receiving a third memory access request, the third memory access request having a third payload size, the first burst length corresponding to the third payload size; and
executing a second memory access command at the DRAM memory array at the first burst length, the second memory access command corresponding to the third memory access request.

5. The memory device of claim 1, the operations further comprising:
receiving a third memory access request having a third payload size equivalent to the first payload size;
determining that the memory request queue does not include another memory access request combinable with the third memory access request at the first burst length;
executing a second memory access command at the DRAM memory array at the first burst length, the second memory access command corresponding to the third memory access request;
masking a portion of returned data returned by the DRAM memory array in response to the second memory access command to generate masked returned data; and
returning the masked returned data in response to the third memory access request.

6. The memory device of claim 1, the operations further comprising:
receiving a third memory access request having a third payload size equivalent to the first payload size;
determining that the memory request queue does not include another memory access request combinable with the third memory access request at the first burst length; and
executing a second memory access command at the DRAM memory array at a second burst length that is different than the first burst length, the second memory access command corresponding to the third memory access request.

7. The memory device of claim 1, the first processor component being a central processor unit (CPU) and the second memory access request being received from a second processor component that is a hardware accelerator component.

8. The memory device of claim 7, the CPU being programmed to access the memory device with a block stride access pattern and the hardware accelerator component being programmed to access the memory device with a sequential access pattern.

9. The memory device of claim 7, the operations further comprising queuing the first memory access command for execution at a memory access command queue.

10. The memory device of claim 1, the operations further comprising:
before the receiving of the first memory access request, receiving the second memory access request from a second processor component; and
queuing the second memory access request to the memory request queue.

11. A method of operating a memory device comprising a Dynamic Random Access Memory (DRAM) memory array comprising a number of memory cells arranged into a number of rows and a number of columns, each respective memory cell of the number of memory cells being part of a column of the number of columns and a row of the number of rows, the method comprising:
receiving a first memory access request from a first processor component in communication with the memory device, the first memory access request having a first payload size;
selecting from a memory request queue, a second memory access request having a second payload size;
providing a first memory access command based on the first memory access request and the second memory access request; and
executing the first memory access command at the DRAM memory array at a first burst length corresponding to a sum of the first payload size and the second payload size.

12. The method of claim 11, the first memory access request indicating a first set of columns of the number of columns and the second memory access request indicating a second set of columns of the number of columns, further comprising determining that the first set of columns is continuous with the second set of columns.

13. The method of claim 11, the first payload size and the second payload size being equal.

14. The method of claim 11, further comprising:
receiving a third memory access request, the third memory access request having a third payload size, the first burst length corresponding to the third payload size; and
executing a second memory access command at the DRAM memory array at the first burst length, the second memory access command corresponding to the third memory access request.

15. The method of claim 11, further comprising:
receiving a third memory access request having a third payload size equivalent to the first payload size;
determining that the memory request queue does not include another memory access request combinable with the third memory access request at the first burst length;
executing a second memory access command at the DRAM memory array at the first burst length, the second memory access command corresponding to the third memory access request;
masking a portion of returned data returned by the DRAM memory array in response to the second memory access command to generate masked returned data; and
returning the masked returned data in response to the third memory access request.

16. The method of claim 11, further comprising:
receiving a third memory access request having a third payload size equivalent to the first payload size;
determining that the memory request queue does not include another memory access request combinable with the third memory access request at the first burst length; and
executing a second memory access command at the DRAM memory array at a second burst length that is different than the first burst length, the second memory access command corresponding to the third memory access request.

17. The method of claim 16, further comprising queuing the first memory access command for execution at a memory access command queue.

18. The method of claim 11, further comprising:
before the receiving of the first memory access request, receiving the second memory access request from a second processor component; and
queuing the second memory access request to the memory request queue.

19. A non-transitory machine-readable medium having instructions thereon that, when executed by at least one processor, cause the at least one processor to perform operations comprising:
receiving a first memory access request from a first processor component, the first memory access request having a first payload size and directed to a memory device comprising a Dynamic Random Access Memory (DRAM) memory array comprising a number of memory cells arranged into a number of rows and a number of columns, each respective memory cell of the number of memory cells being part of a column of the number of columns and a row of the number of rows;
selecting from a memory request queue, a second memory access request having a second payload size;
providing a first memory access command based on the first memory access request and the second memory access request; and
executing the first memory access command at the DRAM memory array at a first burst length corresponding to a sum of the first payload size and the second payload size.

20. The non-transitory machine-readable medium of claim 19, the first memory access request indicating a first set of columns of the number of columns and the second memory access request indicating a second set of columns of the number of columns, further comprising determining that the first set of columns is continuous with the second set of columns.
